(19) United States
(12) Patent Application Publication
(10) Pub. No.: US 2005/0242201 A1
(43) Pub. Date: Nov. 3, 2005

(54) Intelligent environmental room air assist system and method

(76) Inventor: John E. Shorrock, Minneapolis, MN (US)

Correspondence Address: ROBERT A PAJAK;PATENT SERVICES, 14234 NAPLES STREET NE, HAM LAKE, MN, 55304, US

(21) Appl. No.: 10/836,026

(22) Filed: Apr. 30, 2004

(51) Int. Cl. G05D 23/00; F24F 7/00

(52) U.S. Cl. 236/49.3

(57) ABSTRACT

An intelligent environmental room air assist system and method is provided for improving air conditions in a designated room of a building where the average room air is generally established by a building HVAC system. The intelligent environmental air assist system of the present invention includes a plurality of sensors, where each sensor provides a sensor signal indicative of a selected air quality parameter in the designated room. Environmental air-assist components or modules or air modification equipment are located in the designated room, where each of the environmental air-assist components is responsive to a selected command signal for affecting, at least in part, at least one of the air quality parameters. A signal processor for signal processing the sensors signals generates air assist component command signals so as to achieve a desired environmental air quality in the designated room. In exemplary embodiments of the invention, one of the sensors is a CO₂ gas sensor.

### RELATED APPLICATION

This application claims the benefit of priority pursuant to 35 USC 119 of provisional patent application Ser. No. 60/466,920 filed 30 Apr. 2003, the disclosure of which application is hereby incorporated in its entirety by reference herein.

### FIELD OF THE INVENTION

The present invention relates generally to systems and methods for monitoring environmental conditions in a designated space, and more particularly to monitoring environmental conditions within a room, particularly a classroom, and generating, in response to the monitored environmental conditions, command signals coupled to various environmental air-assist components or control modules to affect the environmental conditions in the room in a manner so as improve occupant performance within the room.

### BACKGROUND OF THE INVENTION

Discussion of air quality in schools is discussed in among others, “Ventilation and Indoor Air Quality in Schools,” IEA ECBCS Annex 36 Report on national guidelines and regulations, Air infiltration Review, Volume 21, No 4, September 2000, World Wide Web Edition; Indoor Air Quality Investigations at Five Classrooms, Lee Sc, Chang M., Indoor Air 1999 June:9(2):134-8, both of which are incorporated herein by reference in their entirety. These publications set forth the many environmental (air quality) parameters or variables that may be monitored to determine the environmental conditions of a classroom. Certain conditions have been recognized that deleteriously impact students, e.g., excessive temperature and/or CO gas and/or CO₂ gas.

Commonly, a designated space within a building, i.e., a room, may be characterized by a set of parameters that define the environmental condition of the room. These parameters in an unoccupied room are generally the result of the type and performance of HVAC (heating, ventilating, and air conditioning) equipment, structural parameters of the room (e.g., windows), location of the room (e.g., south facing), time of day, and season, and the like.

In an occupied room, common HVAC equipment may not be responsive to changes in environment conditions of the room, beyond, perhaps, temperature. However, rooms in many building don't even have a temperature sensor coupled to the primary HVAC equipment. Thus, the environment room conditions become, in effect, a result of an open loop control system.

Classrooms or schoolrooms of a complex school building may be used for many purposes, often changing within a single day. The environmental conditions in classrooms may vary greatly during the day depending upon, for example the number of occupants and the type of activity. Schoolrooms are particularly unique because generally they are not large, but they contain a lot of people for a good length of time with the average lesson being an hour.

Schoolrooms are commonly connected to some form of HVAC system, which heats or cools the rooms. There are few controls in the room to regulate the conditions in the room, and at best, a thermostat is provided that may be placed on a wall to regulate temperature. This is so since, commonly, HVAC systems are designed to produce average environmental room conditions in all of the rooms within a building, and so, cannot be very specific for any particular room. This means that environmental conditions in a room will vary depending on its use. A classroom teacher will have little control over the environmental conditions in the room except perhaps by regulating the temperature, which may or may not improve the environmental conditions.

It should be recognized that a fully occupied classroom rapidly departs from the average conditions supplied by the HVAC system. This is so because humans produce a lot of heat (in excess of a 100 watt light bulb) and a lot of exhaled CO₂ gas. In a classroom, upon occupant entering the room, the temperature will quickly start to rise, and the amount of CO₂ gas will also quickly increase. In turn, the students attention will start to lapse due to the increase in temperature and the increased amount of CO₂ gas in the classroom. Unfortunately, there is very little that the teacher can do correct this situation and bring the room back to more of an average environmental air condition that is governed by the building's primary HVAC system.

Generally, the deviation between (a) the current or existing room environmental air without occupants, and (b) the average condition governed by the building HVAC system when the room is full of students or children is not in measured terms large, but in perceived terms may be very large. Exemplary variations may be (i) a rise in temperature from 65 degrees to 70 degrees, and (ii) a change in the quantity of CO₂ gas from 500 parts per million to 1000 parts per million. However, these environmental changes may be problematic enough to cause a serious change in the students' classroom performance, particularly children's cognitive attention and conditions for learning. This is so, since what is experienced is deterioration in the air quality caused by the physics and chemistry changes in the environmental room air affected by the room occupants and the building HVAC system design, and in which the HVAC system it is simply non-responsive.

As students assemble in a classroom, the changes that are taking place in the classroom generally are very gradual. The temperature rises due to body heat and so the hot air rises and cold air from upper portion of the room falls. Further, the concentration of CO₂ gas like-wise increases, and falls closer to the floor (and the room occupants) as it is heavier than the air. The air therefore becomes stratified. As this convection cycle continues, the air in a typical room with a 9-foot ceiling will start to become CO₂ saturated and very warm as all the good air is consumed. This situation leads to poor air quality and drowsy children.

As has been earlier indicated, HVAC systems for school buildings are based on producing an average condition in all the rooms of the school building. The base line average conditions are clearly laid down by bodies like ASHAE (American Society of Heating, refrigerating, and Air conditioning Engineers) and other legislative guidelines published by the State Governments and given to the school boards. HVAC systems, in general, result in most rooms having reasonable environmental air conditions, but in some schools there will always be some rooms, may be 3 to 4, that are known to have poor air quality. This may be caused by many factors some of which are: the design and installation of HVAC system was not correct in the first place; class room walls have been moved and the ducts are now in the wrong place; the HVAC building system is getting old and now works at 95% efficiency and not 100%; the intended use has changed, etc. The result is that the air quality and the energy usage will deteriorate in particular rooms.

### BRIEF DESCRIPTION OF THE INVENTION

The present invention is directed to an apparatus and method that relates how small changes from the average condition of the environmental air established by the HVAC system of a building can be detected and corrected by a self contained intelligent environmental room air assist system or unit with remote sensing in combination with a control system, for example a microprocessor or computer based control system, for generating command signals coupled to environmental air-assist components. This designated “room air assist system” is intended to affect small environmental changes in the air of a designated room, particularly a classroom, equipped with the room air assist system of the present invention to overcome those deviations detected in the room from a desired or pre-selected specification, and bring the room back to the desired or more average environmental air conditions.

In accordance with the present invention, an intelligent environmental room air assist system and method is provided for improving air conditions in a designated room of a building where the average room air is generally established by a building HVAC system. The intelligent environmental air assist system of the present invention includes a plurality of sensors, where each sensor provides a sensor signal indicative of a selected air quality parameter in the designated room. A plurality of environmental air-assist components or modules or air modification equipment are located in the designated room, where each of the environmental air-assist components is responsive to a selected command signal for affecting, at least in part, at least one of the air quality parameters. A signal processor for signal processing the sensors signals generates air assist component command signals so as to achieve a desired environmental air quality in the designated room. In exemplary embodiments of the invention, one of the sensors is a CO₂ gas sensor.

In accordance with the method of the present invention, a plurality of air quality parameters are appropriately located in the designated room, where each of the environmental air-assist components is responsive to a selected command signal for affecting, at least in part, at least one of the air quality parameters. The specific parameters of the room are sensed, and corresponding sensor signals are coupled to a signal processor. In turn, sensors signals are process by the signal processor, perhaps a designated or stand alone signal processor, and generates command signals coupled the to environmental air-assist components so as to achieve a desired environmental air quality in the designated room.

### BRIEF DESCRIPTION OF THE DRAWINGS

FIG. 1 is a perspective view illustrating an exemplary classroom equipped with the intelligent environmental room air assist system and method in accordance with the present invention.

FIG. 2 is a perspective view illustrating a room and the self contained room environmental room air assist unit, associated sensors, and display controller in accordance with the present invention.

FIG. 3 is a block diagram of the intelligent environmental room air assist system and method in accordance with the present invention.

FIG. 4 is a perspective view illustrating a virtual room that graphically depicting a desired environmental room air condition, the “spec spot,” and a spot indicative of the actual environmental room air condition.

### DETAILED DESCRIPTION OF THE INVENTION

In accordance with the present invention, the common classroom or school room cycle of deteriorating poor air quality upon entrance of classroom occupants from rising temperature and increased concentrations of CO₂ gas is corrected by way of command controlled mixing of the room air, and by using, if necessary, fresh air found above the ceiling in the plenum (generally an air space of a false ceiling) or providing a source of O₂, for example, adding horticulture plants to the room to provide additional oxygen, particularly in response to additional lighting that enhances growth.

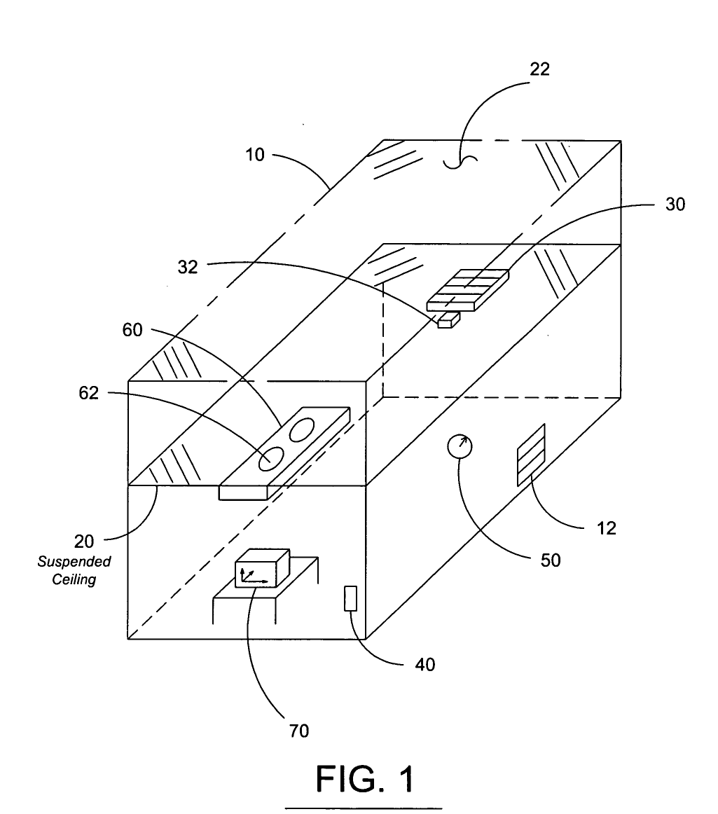

FIG. 1 illustrates particular aspects of the present invention as applied to an exemplary classroom 10 shown in perspective view. Classroom 10 includes a false or suspended ceiling 20, and an upper limit ceiling 22, the combination forming an intrinsic “room air plenum.” Typically the room air plenum will represent 30% of the volume of the room assuming a 9-foot ceiling. Commonly at the interface of the false ceiling 20 is HVAC ventilator 30 through which HVAC conditioned air enters room 10, and exits return air flow exit port 12 which may form in part the HVAC system as is well known.

In accordance with the present invention, (i) remote sensors that provide output signals indicative of the parameter sensed are provided for monitoring selected environmental air variables including among others, CO₂ gas concentrations, temperature, ventilation (air flow), VOC's, Odor, static electricity, and humidity; (ii) environmental air-assist components including, among others, fans, air direction vanes, lights, additional room supplemental heating and cooling components; and (iii) an intelligent signal processor or control unit responsive the remote sensor output signals that provided command signals to appropriate the environmental air-assist components to achieve desired environmental room air conditions.

An intelligent signal processor is provided for signal processing resultant air quality variables or parameters sensed by the remote sensors by way of performing specific calculations in accordance with predetermined calculations, for example, to optimize correct CO₂ gas, temperature, and ventilation (air flow). In turn, the parameter data in accordance preselected algorithms or the like, is processed to generate appropriate command signals coupled to the environmental room air assist components for control thereof, the environmental air-assist components including, among others, fans, vanes, light, heating, and cooling as aforesaid. In the intelligent environmental room air assist system and method of the present invention, the supplementary environmental air-assist components are intended to just bring the room back to more average levels by way of making only marginal changes in the room air to assist or help the building HVAC system by fine-tuning the conditions in a room, which is something the HVAC system cannot do alone.

Referring again to an exemplary simplified classroom illustrated in FIG. 1, there shown are remote sensors including (i) a ventilator air flow sensor 32 that monitors the air flow exiting HVAC ventilator 30; a CO₂ gas sensor 40 shown located in one corner of the room near the floor; and (iii) a temperature sensor 50 positioned on the one of the walls or other location. Of course, many other sensors as recited earlier may also be included.

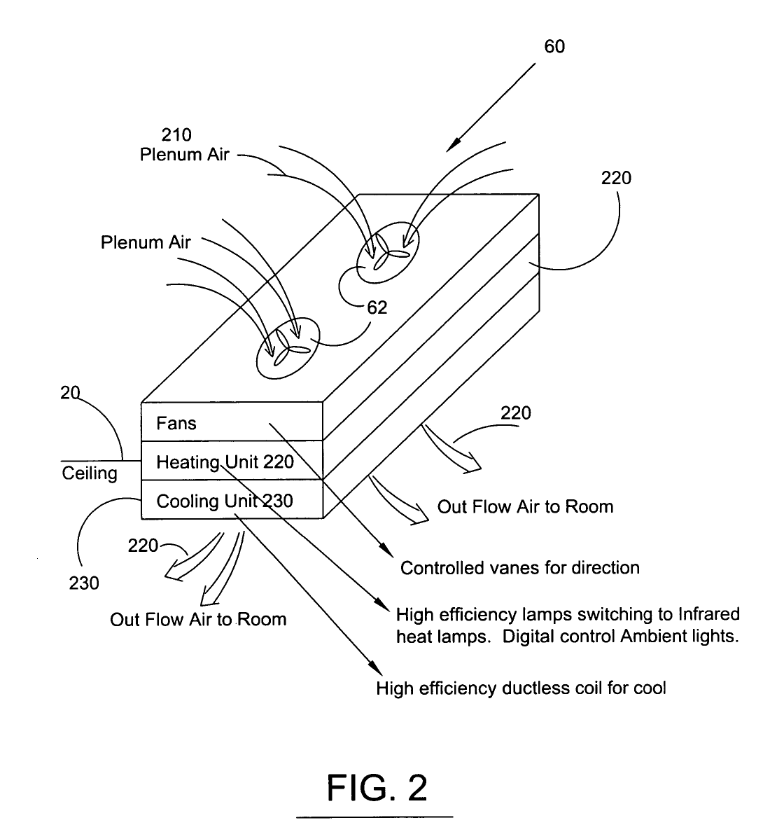

Further illustrated in FIG. 1 is an independent environmental room air-assist heating and cooling component or unit 60 shown in greater detail in FIG. 2. As illustrated in the exemplary figure of FIG. 1, the heating and cooling component 60 may be installed in the space that forms the room air plenum and integral with the false ceiling 20. As illustrated in FIG. 2, supplemental heat and cooling unit 60 may be configured to employ a wide variety of components include intake fans 62 for drawing the plenum air 210 from the room air plenum (formed by the false ceiling as aforesaid) with controlled air flow vanes (not shown) for controlling outflow air 220 in a particular air flow direction, perhaps controlled direction or cyclically varying as desired. The intake air may be directed through a heating unit 220 and a cooling unit 230.

The work load of the heating and cooling unit 60 may be generally quite limited and may be economically provided. For example, heating may be achieved by switching from energy efficient lamps to infrared heat lamps, or digitally controlled ambient lighting. Cooling may simply be provided by switching from plenum air to cooled air from a ductless system, i.e., high efficiency ductless coil for cooling.

The heating and cooling unit 60 may be constructed in manner to simply be substituted for a ceiling tile of a suspended ceiling. It may be advantageous to place the unit in the vicinity of the HVAC ventilator 30 so as to be able to be coupled with air flowing out of the HVAC produced conditioned air. All of which are configured in accordance with a designed environmental room air system in accordance with the present invention for the particular application.

As indicated earlier, the intelligent environmental room air assist system and method of the present invention is intended to be a self contained room environmental air assist control system that is to be fed with multiple variables from selected environmental parameter sensors in the room. As aforesaid, the most common variables are CO₂, O₂, Temperature, Humidity, Volatile Organic compounds (VOCS), Sound, Static electricity, Fungus, Light, Odor and Time, as aforesaid. The intelligent environmental room air assist system of the present invention is intended to respond to a plurality of sensed environmental air parameters or variables, for example, three, that have been chosen to characterize the conditions of a room. The most common selected variables to characterize rooms are as follows:

Example A: CO₂ gas, Temperature, and Ventilation (air flow);

Example B: Temperature, Ventilation, Humidity; and

Example C: O₂, Light, and Ventilation.

In example A, the season would most likely be winter, and in example B; the season would be summer; and in example C, the parameters may be for special rooms that have no windows but are occupied by people for specific work or activity (e.g., gym or a laboratory).

Considering Example A, a self contained room environmental air assist unit is intelligent in so far as it is responsive to variables that have come from sensors, and this sensor data is manipulated by doing calculations, and the result of the calculations are command signals which are directed to the environmental air-assist components, for example motors with microprocessor controls that can control fans, and vanes for directing and circulating air in a room. The technical features of Example A are as follows:

Sensing
Remote Room Sensors: CO₂, Temperature, & Ventilation

Intelligent Processing Of Variables:
Calculates deviation between defined “specification point” and Actual point for three variables using the algorithm below.

Microprocessor driven Controls:
Using calculations from an Algorithm, Fans circulate air using controlled direction air vanes to direct air, and force O₂ rich air from ceiling to floor.

A room can usually be characterized by three variables but in certain instances by monitoring these three variables or conditions in the room that can be finely controlled by combining them with another variable like time. For example, if temperature, ventilation and humidity were being monitored then to avoid fungus and incubation, the conditions in the room would be required to be less than 70 degrees Fahrenheit, have low nutrients, and have low humidity. If conditions were the opposite, say with the temperature 70 degrees and above, humidity high or high dew point, and this was sustained for 48 hours, then the conditions would be right for the fungus to bloom and release the spoors. Thus the variable “time” is important to monitor and combine with the other data to make sure the conditions will not cause fungus blooming or put out a warning that the conditions are right for this to happen.

Another special feature of the system of the present invention is that it may include directional grow lamps that are controlled to go on and off according to a program in the system's signal processor or computer to make special plants like yucca plants and peach lilies, which take in a lot of CO₂ and produce a lot of O₂. Such systems are would be particularly good for rooms with no windows.

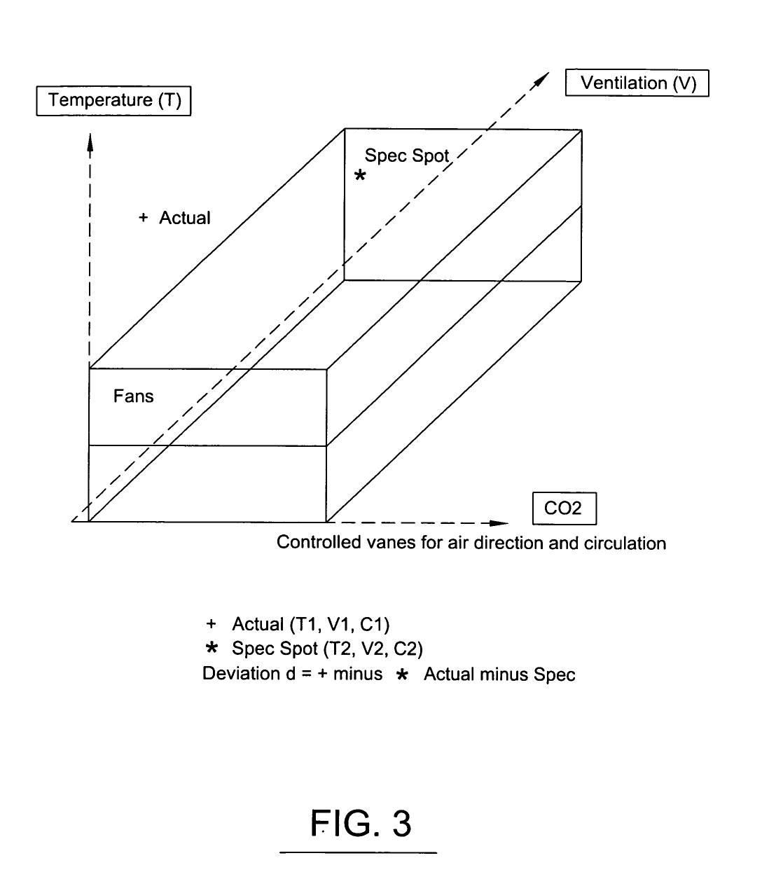

An exemplary basic intelligent environmental air assist system and method in accordance with the present invention is particularly illustrated in FIGS. 1 and 3. The basic system would consist of three variables from the sensors as numerically identified by block 310. Signals representative of the sensed parameters are transmitted by way of RF signal communications generally indicated by block 320. In turn, the RF signals are received by an RF receiver (not shown) coupled to a computer or specialized signal processor for performing a set of instructions or specific algorithm that is intended to calculate the deviation between specific desired environmental room conditions and the current environmental room condition.

A visual display, numerically indicated in FIGS. 1 & 3 by numeral 70 may be coupled to the system signal processor 370 (see FIG. 3) may form in part an ordinary personal computer, PDA, a combination dedicated microprocessor and visual display, or even a notebook computer, that may visually display a visual spec spot representative of desired environmental room condition, and a visual “actual spot” representative of the actual environmental room condition.

The “Spec spot” or “spec point”—for a schoolroom is recommended by ASHRAE to have certain acceptable values for temperature T2, CO₂ gas mathematically represented by C2, and ventilation in cubic feet per minute mathematically represented by V2. These variables may be represented in a three dimensional graph, the point T2, C2, V2 would be the “spec spot”.

Based on the deviation between the desired environmental room conditions and the actual, the algorithm processor may in turn generated command signals or instructions that would be fed back to the ventilator unit where fans and vanes would be controlled depending on the environmental changes needed.

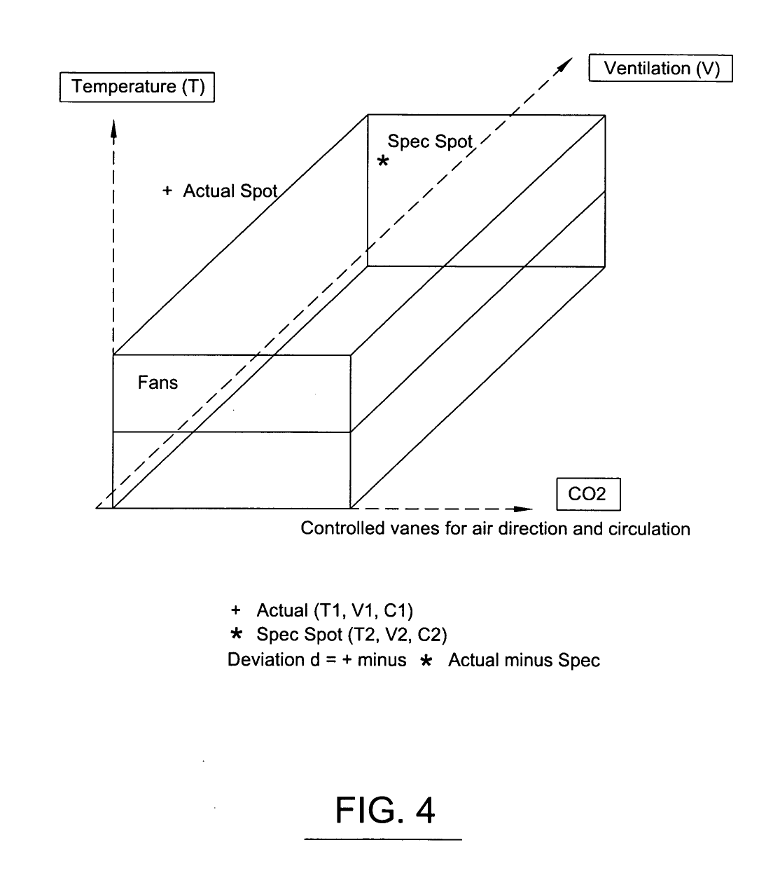

FIG. 4 graphically illustrates an exemplary algorithm that depicts the above described visual “spec spot” representative of desired environmental room condition, and an “actual spot” representative of the actual environmental room condition. A virtual room “Deviation d” between the spec spot and the actual for three variables may be generally mathematically described as:
“Deviation-d”=\sqrt{[T1−T2]²+[V1−V2]²+[C1−C2]²+[N1−N2]²}
Where,
the desired spec spot is defined by T2, V2, and C2,
the actual spot is defined by measured vales T1, V2, and C2,
T represents temperature,
V represents ventilation air flow,
C represents CO₂, and
N represents additional variables as desired.

As previously indicated with reference to FIG. 2, thereshown is a basic schematic on how a self contained room air assist unit could be configured for other variables like light for ambiance and grow lamps for plants. Also heating and cooling elements, e.g., unit 60, could be introduced to supplement the HVAC system. Plenum air could be used once filtered with Hepa filters. These units may be made to fit within the standard ceiling units by removing a tile and dropping in the space as aforesaid.

One way of communicating the actual readings and the optimum readings as expressed by the selected algorithm is by a virtual room as found in computer games. A teacher may be presented with a virtual room on a screen or visual display and receive prompts that would display and permit building of room details. This may include among others such things as: where is the Blackboard located? Where is the teacher's desk located? How many student desks in the room? Where are the windows located and which direction do they face? Where are the lights located and are they on? Where are the radiators located? Where are the input heating vents located? Where is the exhaust vent located? Where is the door located? Where is the thermostat located? Where are the power sockets located? Where are the fume cupboards, Bunsen burners, computers, fridges, TV's, microwave ovens located? By clicking on a mouse these items can be placed in the virtual room and the room becomes the teacher's room. Once this information is collected the system will recommend where to place the sensors for best results and the self contained room environmental air assist unit in the ceiling and show them in the room.

Information from the sensors could be displayed as actual and as a “happy face” as if it were the teacher. If cold it could be blue and frosty and if hot red and sweaty and if tired sleepy eyed. The optimum level for the room from the algorithm could be another “happy face” but all smiley and glowing. A list of recommendations would appear on the screen that could be done to bring the teacher closer to the optimum like open window, open door, and switch on fan and as these take effect the teacher would be shown approaching the optimum from decreasing density to increasing density. Such immediate actions by the teacher may not be enough so an action by the teacher could be to switch on the supplementary ventilator system of the air assist unit. The air assist unit would receive data processed by the teacher's computer (could be processed by air assist unit) as to fan speed and direction of the vanes. The air assist unit would mix the air reducing the concentration of the CO₂ by destratifying the room air and improving air quality. Also the temperature gradients in the room would be reduced and an overall more even temperature would result. (Note: A screen could be made to appear on the teacher's computer that showed the three graphs for of Temperature vs. Ventilation, Temperature vs. CO2 and Ventilation vs. CO₂ for the actual and the spec points. A three dimensional graph could also be shown for all three variables.)

1. A system for improving air conditions in a designated room of a building where the room air is generally established by a building HVAC system, the system comprising:
a plurality of sensors, where each sensor provides a sensor signal indicative of a selected air quality parameter in the designated room;
a plurality of environmental air-assist components located in the designated room, where each of the environmental air-assist component is responsive to a selected command signal for affecting, at least in part, at least one of the air quality parameters; and
a signal processor for signal processing said sensors signals and generating said command signals so as to achieve a desired environmental air in the designated room.

2. The system of claim 1 where one of said sensors is a CO₂ sensor.

3. A method for improving air conditions in a designated room of a building where the room air is generally established by a building HVAC system, the method comprising the steps of:
sensing a plurality of air quality parameters in the designated room, and providing sensor signals indicative thereof;
locating a plurality of environmental air-assist components in the designated room, where each of the environmental air-assist components is responsive to a selected command signal for affecting, at least in part, at least one of the air quality parameters; and
signal processing said sensors signals and generating said command signals so as to achieve a desired environmental air in the designated room.

4. The system of claim 3 where one of said air quality parameters is CO₂.
